(19) United States
(12) Patent Application Publication
(10) Pub. No.: US 2025/0086987 A1
(43) Pub. Date: Mar. 13, 2025

(54) DETECTING DRIVER SURPRISE WITH PUPILLOMETRY AND FACIAL VIDEO

(71) Applicant: TOYOTA RESEARCH INSTITUTE, INC., Los Altos, CA (US)

(72) Inventors: KIMIMASA TAMURA, Cambridge, MA (US); John H. GIDEON, Cincinnati, OH (US); Simon STENT, Oxford (GB); Guy ROSMAN, Newton, MA (US)

(73) Assignees: TOYOTA RESEARCH INSTITUTE, INC., Los Altos, CA (US); TOYOTA JIDOSHA KABUSHIKI KAISHA, TOYOTA-SHI, AICHI-KEN (JP)

(21) Appl. No.: 18/465,097

(22) Filed: Sep. 11, 2023

(51) Int. Cl. G06V 20/59; G06T 7/62; G06V 10/74; G06V 20/40; G06V 20/58; G06V 40/16

(52) U.S. Cl. CPC G06V 20/597; G06T 7/62; G06V 10/761; G06V 20/44; G06V 20/58; G06V 40/171; G06V 40/176

(57) ABSTRACT

Systems and methods are provided for determining driver surprise. The system can receive image data of a driver's pupils and video data of the driver's face over a time interval and determine a diameter of the driver's pupils over the time interval based on the image data. This diameter can be used to generate a pupil confidence value based on the diameter over the time interval. The system can extract facial features from the video data and generate a facial confidence value based on the facial features. A first weight can be applied to the pupil confidence value and a second weight can be applied to the facial confidence value to determine whether the driver is expressing surprise.

### TECHNICAL FIELD

The present disclosure relates generally to detecting hazardous events during operation of a vehicle, and in particular, some implementations may relate to measuring a driver's surprise to the hazardous event.

### DESCRIPTION OF RELATED ART

A person's pupils can dilate in response to the person expressing surprise, cognitive effort, and/or arousal. Pupillometry measures the pupils' diameter over time in response to the expression of surprise. Pupillometry can be used to classify a person's emotions using machine learning methods and pre-segmented data sets. Similarly, facial video of the person can be analyzed using machine learning methods to classify the person's emotions.

### BRIEF SUMMARY OF THE DISCLOSURE

According to various embodiments of the disclosed technology, a method for determining driver surprise can comprise: receiving image data of a driver's pupils and video data of the driver's face over a time interval; determining a diameter of the driver's pupils over the time interval based on the image data and generating a pupil confidence value based on the diameter over the time interval; extracting one or more facial features from the video data and generating a facial confidence value based on the one or more facial features; applying a first weight to the pupil confidence value and applying a second weight to the facial confidence value; and determining whether the driver is expressing surprise based on the weighted pupil confidence value and the weighted facial confidence value.

In some embodiments, the video data comprises video collected from a video camera centered on the driver's face.

In some embodiments, the method further comprises determining a latency between the driver expressing surprise and an event occurring in front of a vehicle of the driver, wherein the first and second weights are determined based on the latency.

In some embodiments, the latency is based on an action threshold associated with vehicle data of the event and a detection threshold associated with the image data.

In some embodiments, the method further comprises receiving video of the front of the vehicle and determining the event based on the video.

In some embodiments, the event comprises a safety hazard.

In some embodiments, the method further comprises determining a classification performance value indicating an accuracy of determining whether the driver is expressing surprise.

In some embodiments, determining whether the driver is expressing surprise comprises calculating a weighted average of the weighted pupil confidence value and the weighted facial confidence value.

According to various embodiments of the disclosed technology, a system for determining driver surprise can comprise a processor and a memory coupled to the processor to store instructions, which when executed by the processor, cause the processor to: receive image data of a driver's pupils and video data of the driver's face over a time interval; receive video data of an event occurring around a vehicle of the driver; determine a diameter of the driver's pupils over the time interval based on the image data and generate a pupil confidence value based on the diameter over the time interval; extract one or more facial features from the video data and generate a facial confidence value based on the one or more facial features; determine a latency based on the one or more facial features, the diameter of the driver's pupils over the time interval, and the video data of the event; apply a first weight to the pupil confidence value and apply a second weight to the facial confidence value based on the latency; and determine whether the driver is expressing surprise based on the weighted pupil confidence value and the weighted facial confidence value.

In some embodiments, the video data comprises video collected from a video camera centered on the driver's face.

In some embodiments, the latency indicates the time between the driver expressing surprise at an event and the event occurring.

In some embodiments, the latency is based on an action threshold associated with vehicle data of the event and a detection threshold associated with the image data.

In some embodiments, the instructions further cause the processor to determine the event is occurring based on the video data.

In some embodiments, the event comprises a safety hazard.

In some embodiments, the instructions further cause the processor to determine a classification performance value indicating an accuracy of determining whether the driver is expressing surprise.

According to various embodiments of the disclosed technology, a non-transitory machine-readable medium can have instructions stored therein, which when executed by a processor, causes the processor to: receive image data of a driver's pupils and video data of the driver's face over a time interval from a plurality of video cameras around the driver; determine a diameter of the driver's pupils over the time interval based on the image data and generate a pupil confidence value based on the diameter over the time interval; extract one or more facial features from the video data and generate a facial confidence value based on the one or more facial features; determine whether the driver is expressing surprise based on the pupil confidence value and the facial confidence value; determine a latency between the driver expressing surprise and an event occurring around a vehicle of the driver; and alter an operating characteristic of the vehicle based on the driver expressing surprise while accounting for the latency.

In some embodiments, the facial confidence value is determined by a weighted average of individual facial confidence values for each of the plurality of video cameras.

In some embodiments, the latency is based on an action threshold associated with vehicle data of the event and a detection threshold associated with the image data.

In some embodiments, the instructions further cause the processor to apply a first weight to the pupil confidence value and apply a second weight to the facial confidence value.

In some embodiments, determining whether the driver is expressing surprise comprises calculating a weighted average of the weighted pupil confidence value and the weighted facial confidence value.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for detecting driver surprise in accordance with one embodiment of the systems and methods described herein.

FIG. 3 illustrates an example system for detecting driver surprise using pupillometry and facial video, in accordance with various embodiments.

FIG. 4 illustrates an example method for detecting driver surprise in accordance with various embodiments.

FIG. 5 is an example computing component that may be used to implement various features of embodiments described in the present disclosure.

The figures are not exhaustive and do not limit the present disclosure to the precise form disclosed.

### DETAILED DESCRIPTION

Conventional machine learning models can be executed on pre-segmented data sets for events occurring during a recorded time period. In the context of vehicle operation, these events can focus on hazardous driving events, such as car crashes or near misses. For instance, a data set may pre-segment video data into various time intervals indicating different periods of an event such as a car crash, including the start of the event, end of the event, or point of impact. Because this data is pre-segmented, conventional machine learning models do not account for latency. Here, latency refers to the time it takes the driver to perceive and act in response to a hazardous situation occurring. For instance, a driver may express surprise that a vehicle is about to experience a collision. This driver can express surprise via facial expressions or pupil dilation upon seeing the vehicle with which it is about to collide. Due to latency, it will take the driver some time to act (i.e., hit the brakes, swerve, etc.) after seeing the hazard. A response can include braking, facial expressions, and/or pupil changes. The order of these actions may depend on the individual driver and the given situation. Latency can vary greatly between events. This variance can cause conventional machine learning models to overestimate or underestimate latency, leading to inaccurate perceptions of an event. In particular, the variance or deviation of latency can affect how a machine learning model detects when an event is perceived. Conventional machine learning models may depend on low deviations in latency in order to accurately determine when an event is perceived. Indeed, latency has a great effect on a machine learning model's detection performance.

Embodiments of the systems and methods disclosed herein can account for variances in latency using a real-time detection system. The system can explore driver visual cues to understand the driver's perception of risk to an imminent hazardous event. The driver's perception can indicate the driver's awareness to an upcoming hazardous event. This awareness can determine whether a driver can appropriately handle the hazardous event (e.g., whether the driver can appropriately navigate/control the vehicle to avoid/otherwise address the upcoming hazardous event) or whether vehicle systems should take over to mitigate or prevent the hazardous event. The driver's perception can also assist in predicting the severity of an event, which can inform the operation of vehicle systems in response to the event. In situations where a real time warning is not fast enough, the context gained from the system could still be used to better inform later notifications to the driver or make the vehicle drive more defensively. Additionally, the detected severity could be used to automatically annotate a larger collection of driving data, which can be included in late trainings to improve the model. These visual cues can include image/video data of a driver's pupils and facial image/video data of the driver during, before, and after an event. As alluded to above, pupillometry can be used to classify a person's emotions such as surprise using various machine learning models. This data can be obtained in real time during a hazardous event based on one or more cameras recording the driver's reaction to an event. Events can be recorded when a driver is driving a vehicle or can be recorded when a driver participates in a simulation of vehicle operation. An event can comprise hazardous situations for a driver such as collisions, near misses, obstacles in the road, sudden traffic, inclement weather, or any other event that increases risk, e.g., safety risk, to a driver. Pupillometry and image analysis can be applied to a neural network to determine surprise in reaction to the hazardous event. In particular, the neural network can classify whether an event is perceived via surprise and when an event is perceived while taking into account the latency. As alluded to above, latency can refer to the delay between the driver perceiving the event and the driver taking action in response to perception of the event (e.g., hitting the brakes, veering in a different direction, etc.). Because of this latency, the driver's perception of an event alone cannot fully inform how the driver will respond to the event. Therefore, predictions as to the driver's future actions would not be accurate without taking latency into account. Depending on the latency, the pupil data and facial image data can be weighted differently, such that the neural network can maintain accuracy despite a variance of latency. For instance, the facial image data may be weighted more in low latency situations. If the latency is not a factor, the pupil data may be weighted more to tune the neural network's detection threshold. The neural network can be trained and updated as needed to maintain accuracy. Accuracy can be evaluated using a classification performance metric, which can increase or decrease depending on the latency and weight to the image data. The neural network can aim to maximize the classification performance metric during training.

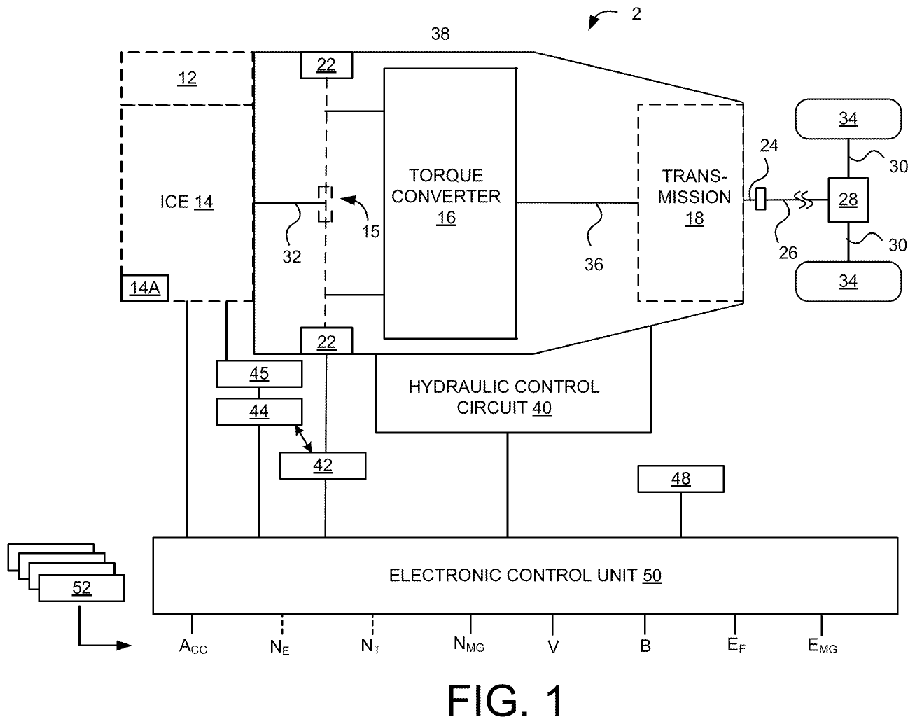

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for detecting driver surprise can be implemented in other types of vehicles including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, NE, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

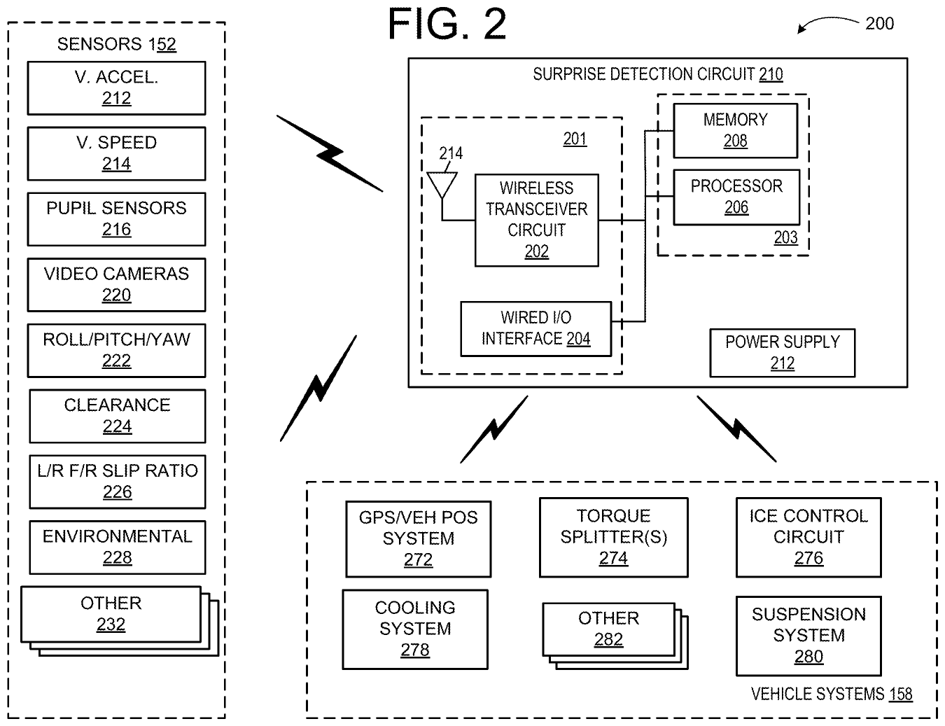

FIG. 2 illustrates an example architecture for detecting driver surprise in accordance with one embodiment of the systems and methods described herein. In some embodiments, surprise detection system 200 can be implemented in-vehicle to execute while a driver is operating the vehicle. In other embodiments, surprise detection system 200 can operate over a cloud or other network. Referring now to FIG. 2, in this example, surprise detection system 200 includes a surprise detection circuit 210, a plurality of sensors 152 and a plurality of vehicle systems 158.

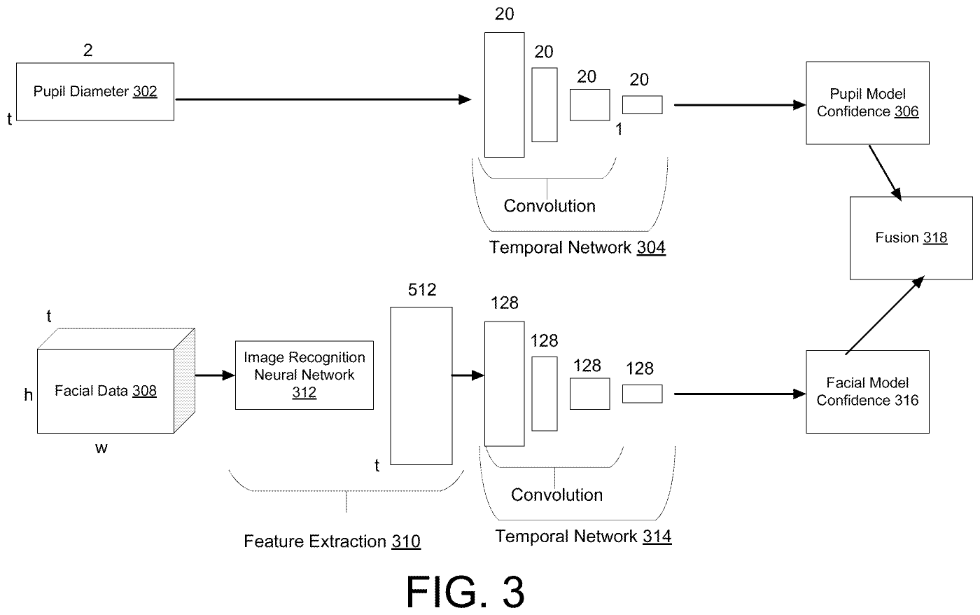

As described further below in FIG. 3, sensors 152 can communicate image and video data of a driver while the vehicle is in operation. In particular, sensors 152 can include image and video sensors to obtain images of the driver's pupils and video of the driver's face and facial expressions. Sensors 152 can communicate this data to surprise detection circuit 210 to determine whether the driver is expressing surprise.

Sensors 152 and vehicle systems 158 can communicate with surprise detection circuit 210 via a wired or wireless communication interface. Although sensors 152 and vehicle systems 158 are depicted as communicating with surprise detection circuit 210, they can also communicate with each other as well as with other vehicle systems. In embodiments where surprise detection system 210 is implemented in-vehicle, surprise detection circuit 210 can be implemented as an ECU or as part of an ECU such as, for example electronic control unit 50. In other embodiments, surprise detection circuit 210 can be implemented independently of the ECU, such that sensors 152 and vehicle systems 158 can communicate to surprise detection circuit 210 over a network, server or cloud interface. In embodiments where surprise detection circuit 210 operates over a network, surprise detection circuit 210 can execute the architecture described below in FIG. 3 and communicate back to sensors 152 and vehicle systems 158.

Surprise detection circuit 210 in this example includes a communication circuit 201, a decision circuit 203 (including a processor 206 and memory 208 in this example) and a power supply 212. Components of surprise detection circuit 210 are illustrated as communicating with each other via a data bus, although other communication in interfaces can be included. Surprise detection circuit 210 can receive sensor data as described above and input that sensor data into one or more machine learning algorithms through decision circuit 203. Decision circuit 203 can execute a pupil determination model and a facial determination model. The pupil determination model can generate a surprise determination for pupil image data based on pupil dilation. The facial determination mode can also generate a surprise determination. Decision circuit 203 can weight these determinations to determine whether the driver is expressing surprise. As described further below, surprise detection circuit 210 can use the final determination to determine whether to alter operating characteristics of the vehicle. Surprise detection circuit 210 can communicate with vehicle systems 158 through communication circuit 201 in response to a determination that the driver is expressing surprise.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory, and may be configured to store data and other information as well as operational instructions that may be used by the processor 206 to surprise detection circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up surprise detection circuit 210.

Communication circuit 201 includes either or both a wireless transceiver circuit 202 with an associated antenna 205 and a wired I/O interface 204 with an associated hardwired data port (not illustrated). Communication circuit 201 can provide for V2X and/or V2V communications capabilities, allowing local surprise detection circuit 210 to communicate with edge devices, such as roadside unit/equipment (RSU/RSE), network cloud servers and cloud-based databases, and/or other vehicles via a network. For example, V2X communication capabilities allows surprise detection circuit 210 to communicate with edge/cloud devices, roadside infrastructure (e.g., such as roadside equipment/roadside unit, which may be a vehicle-to-infrastructure (V2I)-enabled streetlight or cameras, for example), etc. Local surprise detection circuit 210 may also communicate with other vehicles over vehicle-to-vehicle (V2V) communications. For example, current driving conditions/environment data may include data relayed to the ego vehicle from, e.g., an RSE (instead of from an on-board sensor, such as sensors 252), which can then be relayed to the surprise detection server.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with surprise detection circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by surprise detection circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which surprise detection system 200 is implemented. In the illustrated example, sensors 152 include vehicle acceleration sensors 212, vehicle speed sensors 214, pupillometry sensors 216 (to measure the pupil diameter of the driver in real-time), video cameras 220 (e.g., of the interior of the vehicle to monito driver reactions, and of the environment surrounding the vehicle to capture events occurring around the vehicle), accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of surprise detection system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

Communication circuit 201 can be used to transmit and receive information between surprise detection circuit 210 and sensors 152, and surprise detection circuit 210 and vehicle systems 158. Also, sensors 152 may communicate with vehicle systems 158 directly or indirectly (e.g., via communication circuit 201 or otherwise).

FIG. 3 illustrates an example architecture for determining driver surprise, in accordance with various embodiments. As described above in FIG. 2, the architecture of FIG. 3 can be executed in-vehicle or through a server. In embodiments where FIG. 3 is executed in-vehicle, the architecture can be executed through the vehicle's ECU (e.g., through surprise detection circuit 210). This system can be divided into a pupil determination model and a facial determination model. The pupil determination model can generate a surprise determination for pupil image data based on pupil dilation. The pupil determination model can receive pupil diameter data 302 to input into temporal network 304. As the system in FIG. 3 can operate in real time, pupil diameter data 302 can comprise the last five seconds of image/video data or any preceding time interval. Image data can be generated from a camera or any eye tracker that can receive the image data and determine the pupil's diameter over time. In some embodiments, pupil diameter data 302 may be recorded at 100 Hz to produce a plurality of image frames. These image frames can be analyzed to determine the pupil diameter. Pupil diameter data 302 can be recorded at various rates depending on the number of diameter datapoints to be analyzed.

Pupil diameter data 302 can be input into temporal network 304 to determine the pupil's dilation patterns. Temporal network 304 can comprise any neural network that can analyze pupil diameter data 302 and identify trends in the changes of pupil diameter. Temporal network 304 can comprise three layers of convolution and an adapting max pooling function to generate pupil model confidence 306. Pupil model confidence 306 can comprise a scalar value of confidence to indicate whether a surprise response occurred based on the evaluation of the phasic dilation patterns. Pupil model confidence 306 can stand alone as a surprise determination or may be combined with results from the facial determination model.

The facial determination model may receive one or more images of a driver's face. Facial data 308 can be obtained from one or more cameras surrounding the driver and focused on the driver's face. The cameras can comprise any video camera that can be mounted to the interior of a vehicle to face the driver in the driver's seat. In some embodiments, the system can include one center camera cropped to a face rectangle. This face rectangle may be 48×48, or may comprise a different size square. The face rectangle can be cropped to tightly surround the driver's face. In some embodiments, multiple cameras can be used to receive images from multiple angles. As with pupil diameter data 302, facial data 308 can be recorded from the previous five seconds or another time interval. In some embodiments, facial data 308 can be recorded at 15 Hz to generate frames with sufficient differences to detect surprise.

Facial data 308 can be input into feature extraction module 310 to analyze each image or video frame. In some embodiments, feature extraction module 310 can comprise an image recognition neural network 312 that can identify the driver's facial expressions in the frame. Image recognition neural network 312 can output facial data with corresponding facial expressions and segmenting. Similar to the pupil determination model, the facial data can be input into a second temporal network 314 to determine whether the driver is expressing surprise. Temporal network 314 may also comprise three layers of convolution and an adapting max pooling function. Temporal network 314 may match the structure of temporal network 304 but with different channel dimensions. For example, as illustrated in FIG. 3, temporal network 304 may have a channel dimension of 20, while temporal network 314 may have a channel dimension of 128. Temporal network 314 may have a higher channel dimension to accommodate the complexity of the facial images. Temporal network 304 may have a lower channel dimension as the images of the driver's pupil are less complex.

Temporal network 314 can generate facial model confidence 316. As with pupil model confidence 306, facial model confidence 316 can stand alone as a surprise determination or may be combined with pupil model confidence 306. In the case where there are multiple video cameras capturing facial data, a facial model confidence can be calculated for each video camera. Facial model confidence 316 can be generated from a weighted average of the individual facial model confidences. Furthermore, pupil model confidence 306 and facial model confidence 316 can also be combined to generate an overall confidence value. To combine these confidence values, fusion 318 can occur to generate a combined scalar value of confidence. Fusion 318 can comprise weighting an average of pupil model confidence 306 and facial model confidence 316. In some embodiments, fusion 318 can occur before temporal networks 304/314. In this case, one confidence value can be determined via a temporal network instead of separate confidence values for the pupil model and facial model.

As mentioned above, these values can be weighted differently according to latency. Latency can be determined with pupil and facial data in combination with vehicle data. Vehicle data can comprise any data illustrating the vehicle's actions during the hazardous event. For example, the vehicle data can comprise data on the amount of braking force over time. The vehicle data can be collected over a same time period as that of the pupil and/or facial data to determine when the driver acted in response to the hazardous event. This time period can include the driver's perception of the hazardous event, the driver's reaction to the hazardous event, and the point where the driver reaches the hazardous event. Latency between the driver's perception and reaction to the hazardous event can be calculated as the difference in time between a detection threshold and an action threshold. The detection threshold can comprise a threshold time in the facial or pupil data where the hazardous event is considered to be “perceived”.

This detection threshold may be based on, for example, a specific pupil diameter, a rate of change of pupil diameter, a rate of change in the facial data, or an identified facial characteristic. The action threshold can indicate the time where the driver acted, such as by braking the vehicle, swerving, etc. The action threshold can be identified at various points in the image/action data. In the example where the vehicle data measures the braking force, the action threshold may be the point where the driver exerts a certain amount of braking force. The action threshold may also be based on the rate of change in the braking force or any indication that the braking is occurring to fully respond to the hazardous event. Latency can be calculated using the detection threshold and the action threshold to determine the weights to be assigned to pupil model confidence 306 and facial model confidence 316.

The weighted confidence can also be associated with a classification performance value. The classification performance value can indicate the accuracy of the system's determinations in the pupil determination model, facial determination model, or fusion 318. The classification performance value can indicate the effects of latency on the system's accuracy, such that the system can account for various latencies to make more accurate determinations. In some embodiments, the classification performance value can increase where longer latency is allowed.

The models described above can be trained in various ways and retrained as necessary. In some embodiments, the models can be trained using videos of events or non-events occurring in front of a vehicle. These videos can correspond to facial and pupil data of the driver. The accuracy of the models' determinations can be evaluated and tuned accordingly. In some embodiments, the data can be tuned by chunk sampling to cover a full dataset. In chunk sampling, five second intervals of the videos can be sampled to obtain a large amount of training samples. Alternatively, training can involve a region of interest labeling technique. The region of interest can be defined by a center offset from the beginning of a five second interval. The label can be defined by the overlap between the region of interest and the time interval where the event occurs. Applying this labeling can address the potential delay between when the event starts and when the driver reacts to the event. The system can incorporate other training methods to vary the scope and weights of the pupil and facial confidence values.

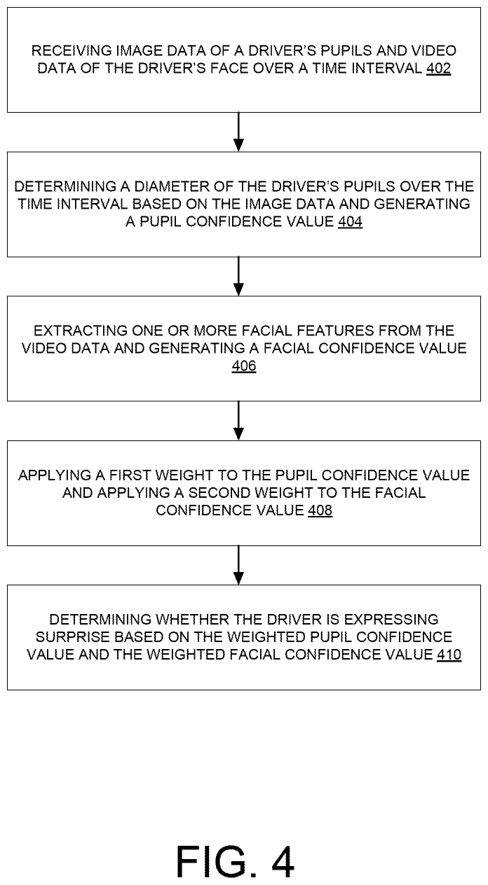

FIG. 4 illustrates an example method incorporating the systems described above. At block 402, the system can receive image data of a driver's pupils and video data of the driver's face over a time interval. As described above, the image data of the driver's pupils can comprise the last five seconds of image data or any time interval. Image data can be generated from a camera or any eye tracker that can receive the image data and determine the pupil's diameter over time. Facial data can be obtained from one or more cameras surrounding the driver and focused on the driver's face. In some embodiments, the system can include one center camera cropped to a face rectangle. This face rectangle may be 48×48, or may comprise a different size square to tightly surround the driver's face. In some embodiments, multiple cameras can be used to receive images from multiple angles.

At block 404, the system can determine a diameter of the driver's pupils over the time interval based on the image data and generate a pupil confidence value. As described above, the image data can be input into temporal network 304 to determine the pupil's dilation patterns. The temporal network may comprise three layers of convolution and an adapting max pooling function. The pupil confidence value can comprise a scalar value of confidence to indicate whether a surprise response occurred based on the evaluation of the phasic dilation patterns.

At block 406, the system can extract one or more facial features from the video data and generate a facial confidence value. As described above, the facial features can be input into a second temporal network to determine whether the driver is expressing surprise. The temporal network may also comprise three layers of convolution and an adapting max pooling function. The temporal network can generate a facial confidence value. In the case where there are multiple video cameras capturing facial data, a facial confidence value can be calculated for each video camera. The overall facial confidence value can be generated from a weighted average of the facial model confidences.

At block 408, the system can apply a first weight to the pupil confidence value and apply a second weight to the facial confidence value. As described above, the weights can be determined based on the latency. Latency can be determined with pupil and facial data in combination with vehicle data. Latency can be calculated as the difference in time between a detection threshold and an action threshold. The detection threshold can comprise a threshold time in the image or pupil data where the hazardous event is considered to be “perceived”. The action threshold can indicate the time where the driver acted in response to perceiving the event. Latency can be calculated using the detection threshold and the action threshold to determine the weights to be assigned to the pupil confidence value and the facial confidence value.

At block 410, the system can determine whether the driver is expressing surprise based on the weighted pupil confidence value and the weighted facial confidence value. To combine these confidence values, fusion can occur to generate a combined scalar value of confidence. Fusion can comprise a weighted average of the pupil confidence value and the facial confidence value. The weighted confidence can also be associated with a classification performance value. The classification performance value can indicate the accuracy of the system's determinations. The classification performance value can indicate the effects of latency on the system's accuracy, such that the system can account for various latencies to make more accurate determinations.

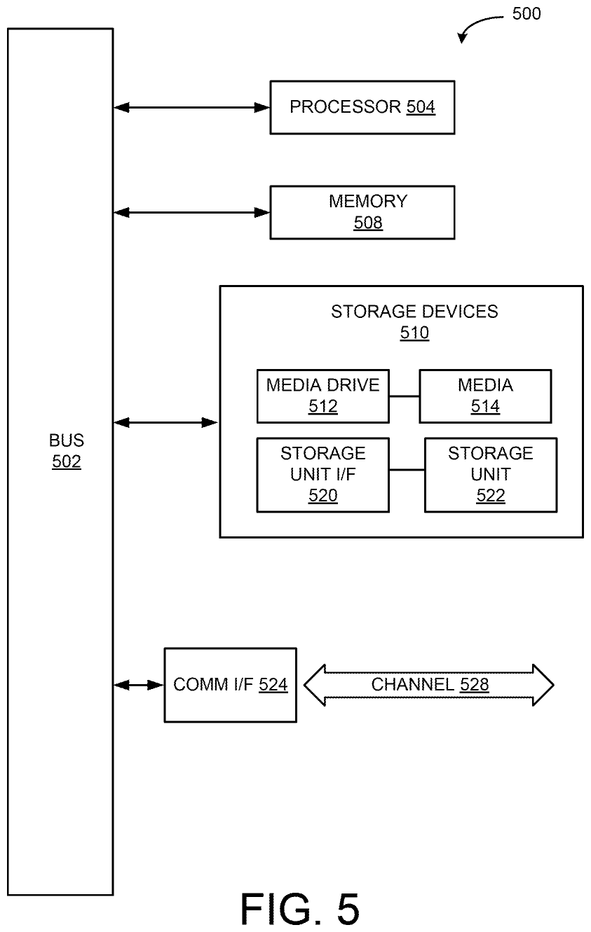

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for determining driver surprise, comprising:
receiving image data of a driver's pupils and video data of the driver's face over a time interval;
determining a diameter of the driver's pupils over the time interval based on the image data and generating a pupil confidence value based on the diameter over the time interval;
extracting one or more facial features from the video data and generating a facial confidence value based on the one or more facial features;
applying a first weight to the pupil confidence value and applying a second weight to the facial confidence value; and
determining whether the driver is expressing surprise based on the weighted pupil confidence value and the weighted facial confidence value.

2. The method of claim 1, wherein the video data comprises video collected from a video camera centered on the driver's face.

3. The method of claim 1, further comprising determining a latency between the driver expressing surprise and an event occurring in front of a vehicle of the driver, wherein the first and second weights are determined based on the latency.

4. The method of claim 3, wherein the latency is based on an action threshold associated with vehicle data of the event and a detection threshold associated with the image data.

5. The method of claim 3, further comprising receiving video of the front of the vehicle and determining the event based on the video.

6. The method of claim 5, wherein the event comprises a safety hazard.

7. The method of claim 1, further comprising determining a classification performance value indicating an accuracy of determining whether the driver is expressing surprise.

8. The method of claim 1, wherein determining whether the driver is expressing surprise comprises calculating a weighted average of the weighted pupil confidence value and the weighted facial confidence value.

9. A system for determining driver surprise, comprising:
a processor; and
a memory coupled to the processor to store instructions, which when executed by the processor, cause the processor to:
receive image data of a driver's pupils and video data of the driver's face over a time interval;
receive video data of an event occurring around a vehicle of the driver;
determine a diameter of the driver's pupils over the time interval based on the image data and generate a pupil confidence value based on the diameter over the time interval;
extract one or more facial features from the video data and generate a facial confidence value based on the one or more facial features;
determine a latency based on the one or more facial features, the diameter of the driver's pupils over the time interval, and the video data of the event;
apply a first weight to the pupil confidence value and apply a second weight to the facial confidence value based on the latency; and
determine whether the driver is expressing surprise based on the weighted pupil confidence value and the weighted facial confidence value.

10. The system of claim 9, wherein the video data comprises video collected from a video camera centered on the driver's face.

11. The system of claim 9, wherein the latency indicates the time between the driver expressing surprise at an event and the event occurring.

12. The system of claim 11, wherein the latency is based on an action threshold associated with vehicle data of the event and a detection threshold associated with the image data.

13. The system of claim 11, wherein the instructions further cause the processor to determine the event is occurring based on the video data.

14. The system of claim 11, wherein the event comprises a safety hazard.

15. The system of claim 9, wherein the instructions further cause the processor to determine a classification performance value indicating an accuracy of determining whether the driver is expressing surprise.

16. A non-transitory machine-readable medium having instructions stored therein, which when executed by a processor, cause the processor to:
receive image data of a driver's pupils and video data of the driver's face over a time interval from a plurality of video cameras around the driver;
determine a diameter of the driver's pupils over the time interval based on the image data and generate a pupil confidence value based on the diameter over the time interval;
extract one or more facial features from the video data and generate a facial confidence value based on the one or more facial features;
determine whether the driver is expressing surprise based on the pupil confidence value and the facial confidence value;
determine a latency between the driver expressing surprise and an event occurring around a vehicle of the driver; and
alter an operating characteristic of the vehicle based on the driver expressing surprise while accounting for the latency.

17. The non-transitory machine-readable medium of claim 16, wherein the facial confidence value is determined by a weighted average of individual facial confidence values for each of the plurality of video cameras.

18. The non-transitory machine-readable medium of claim 16, wherein the latency is based on an action threshold associated with vehicle data of the event and a detection threshold associated with the image data.

19. The non-transitory machine-readable medium of claim 16, wherein the instructions further cause the processor to apply a first weight to the pupil confidence value and apply a second weight to the facial confidence value.

20. The non-transitory machine-readable medium of claim 19, wherein determining whether the driver is expressing surprise comprises calculating a weighted average of the weighted pupil confidence value and the weighted facial confidence value.
